(19) United States
(12) Patent Application Publication
(10) Pub. No.: US 2010/0024734 A1
(43) Pub. Date: Feb. 4, 2010

(54) SLENDER MILKING HOSE SUPPORT TREE

(76) Inventors: Glenn Simon Gingrich, Trempealeau, WI (US); Suzanne Smith Lane, Galesville, WI (US)

Correspondence Address: Kenneth Bower, 314 Ironstone Lane, Elverson, PA, 19520, US

(21) Appl. No.: 12/512,083

(22) Filed: Jul. 30, 2009

Related U.S. Application Data
(60) Provisional application No. 61/084,989, filed on Jul. 30, 2008.

(51) Int. Cl. A01K 1/12; A01J 5/00

(52) U.S. Cl. 119/14.02; 119/14.03

(57) ABSTRACT

A device and method of use of a hose support device for supporting hoses that extend from an animal attached milking machine to a central milk collection system is disclosed. Adaptation to animal size and position in the stall is provided with a coarse adjustment of the hose support tree. Finer adjustment for optimizing milk flow and preserving animal health is accomplished by providing a selection of hose positions that also hold the hose in position. Further adaptations include attachment to milking stalls of differing configurations including rotary milking parlors.

### CROSS-REFERENCE TO RELATED APPLICATIONS

This application claims U.S. Provisional Application No. 61/084,989 filed on Jul. 30, 2008.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention represents a significant step forward in the field of milking parlor efficiency. Milking machine hose alignment affects milk flow rate, milking time, milking stress on the animal, milk quality, teat end condition, utter health and the cow's productive longevity. An efficient milking parlor can also support a larger herd than an inefficient one and milk the larger herd without incurring significant additional capital expense of expanding the milking facilities.

The present invention provides a device and method of use for a device that positions the milking cluster of a milking machine in a position that optimizes the milk output from the animal. The preferred embodiment of the present invention is a device for supporting hoses that extend from an animal attached milking machine to a central milk collection system. The position of the hoses have a major influence on the position of the milking machine cluster which is the key factor for an efficient milking operation.

The time required to milk an animal can be divided into the following periods:
a. Moving the animal into the milking stall,
b. Cleaning the teats before attaching the milking machine,
c. Attaching the milking cluster to the cow and aligning the hoses,
d. Extracting the milk,
e. Disengaging the milking machine,
f. Applying a protective treatment to the animal teats,
g. Moving the animal out of the milking stall,
h. Cleaning of the milking stall and equipment

The present invention primarily affects the time required for steps c, d and e. This is accomplished by adjusting the level of the hoses running between the teat cups and the central milk gathering equipment to enhance the flow of the milk. The preferred embodiment of the present invention is also simple and rapid in its application and fulfills the need for low initial cost required because one hose support is usually required for each of many milking parlor stalls. There are, however, additional advantages to use of the present invention because a balanced milking machine harvests milk faster and places less stress on the animal teats resulting in a healthier and more easily managed herd.

In use the present invention allows for three axis adjustment of the position of the milking cluster on the teats of the animal. The milking cluster position is altered by controlling the position of the hoses that connect the milking cluster with the central milk collecting system. In the preferred embodiment of the present invention these hoses pass between the rear legs of the animal. The first or lateral hose adjustment is illustrated in FIG. 1b and compensates for the animals sideways position or leaning in the milking stall. The second adjustment is for the vertical position of the hoses which primarily compensates for the elevation of the animal's teats above the platform of the milking stall. The difference between FIGS. 3 and 4 as well as the difference between FIGS. 6 and 7 are the adjustment of hose position to adapt to animals whose teats hang close or further from the milking stall platform. The third adjustment is the position of the milking cluster towards the head or the hind quarters of the animal. This adjustment equalizes the weight of the milking cluster on the front and rear teats due to the height of the teats above the milking stall platform and due to the position of the animal in the stall forward and aft.

The preferred embodiment of the present invention adapts to animal proportions, any lopsidedness and position in the stall with a coarse adjustment of the hose support tree. Finer adjustment are to optimize milk flow, preserve animal health and avoid milking cluster disengagement from the animals stepping on hoses that reduces milking rates due to pinching of the vacuum and air hoses. The hose support is also pivoted so that coming against an obstruction will result in the hose tree pivoting out of the way which could be the case with a rotary milking parlor stall configuration.

A number of attempts at hose support design are found in the art exemplified by: The invention of Sanford (U.S. Pat. No. 5,960,738) supports the hoses at fixed relative positions at milking parlor curb level allowing only lateral adjustment as shown in FIG. 1b. This design lacks the ability to position the hoses to compensate for the level of the teats above the milking stall platform. The upper hose support loosely holds the hoses on a flat surface which will not hold the hoses in position. The lower hose support is fastened to the milk hose providing no vertical adjustment thus this design fails to provide efficient and comfortable milk extraction and does little to keep the hoses out from under the animal hooves. This design is not affected by the constraints of installation in a rotary milking parlor.

A new product offered by Chinook Dairy Service and attributed to Peter Maljaars has become known in the market and is essentially shown in FIGS. 3 and 4. Like the device to Stanford there is a lateral hose support adjustment. However there is only one vertically adjustable hose position for all hoses which only allows for an adjustment to the level of the animal teats above the platform of the stall. Like the hose support of Sanford the additional hoses are supported on a flat surface which allows adjustment of the milking cluster forward towards the head or backwards towards the hind quarters of the animal. However the hoses are not gripped in this position, loosing the adjustment, if the animal shifts position. This design relies on sensing a potential collision with a rotary milking parlor animal bridge and lowering the milking hose support by releasing an air operated brake.

### BRIEF SUMMARY OF THE INVENTION

The present invention is intended to overcome the aforementioned short comings of milking hose supports shown in the art as well as achieving the following objectives:

An object of the present invention is to snugly hold the hoses in the hose engaging members to hold the hose positions regardless of movement by the animal.

A second object of the present invention is to provide a milking hose support that is easy to clean. This is accomplished by making the components from inert plastic and minimizing crevices that can contain bacteria.

Another object of the present invention is mounting on a variety of stationary milking platform configurations. This is accomplished by modular construction with base modules that adapt to all known milking parlor configurations.

Another object of the present invention is use in a rotary milking parlor configuration. This is achieved by the support tree being connected by the base with a pivot so the tree will move out of the way of rotary bridge as it passes over the milking platform curb,

Yet another object of the present configuration is ease of use with an automated machine retraction device. This is accomplished by hose engagement members with open tops allowing the hoses to be lifted vertically without interference.

Yet another object of the present invention is enhancing milking efficiency and animal health by balancing the weight of hoses supported by animal teats. This is accomplished by providing hose engaging members in at least two elevations that can be adjusted to a rough position and then fine positioning to balance the milking machine by selection of which hose goes in which hose engagement member.

Still another object of the present invention is to adapt to animals having differing physical proportions. This is primarily accomplished by the two support tree positions roughly adjusting the vertical position of the hoses which is typically adjusted concurrently with the in and out adjustment of the hoses for balance of the milking cluster.

Still another object of the present position is to adapt to animals standing in varying positions in the stall. This is accomplished by the base sliding laterally on the rails.

None of the above Patents or Published Patent Applications singly or in combination is seen to describe the present invention as claimed.

### BRIEF DESCRIPTION OF THE SEVERAL VIEWS OF THE DRAWING(S)

FIG. 1a: Is a side view of a first “prior art” milking hose support applied to an animal of normal proportions.

FIG. 1b: A rear view of a first “prior art” milking hose support applied to an animal of normal proportions.

FIG. 1c: A magnified view of FIG. 1b.

FIG. 2: Is a side view of a first “prior art” milking hose support applied to an animal having longer than normal legs.

FIG. 3: Is a side view of a second “prior art” milking hose support applied to an animal of normal proportions.

FIG. 4: Is a side view of a second “prior art” milking hose support applied to an animal having longer than normal legs.

FIG. 5: Is a plan, side and bottom view of the preferred embodiment of the present invention.

FIG. 6. Is a side view of the preferred embodiment of present invention applied to an animal of normal proportions.

FIG. 7: Is a side view of the preferred embodiment of the present invention applied to an animal with long legs.

FIG. 8: Is a block diagram of the method of use of the present invention.

### DETAILED DESCRIPTION OF THE PRIOR ART

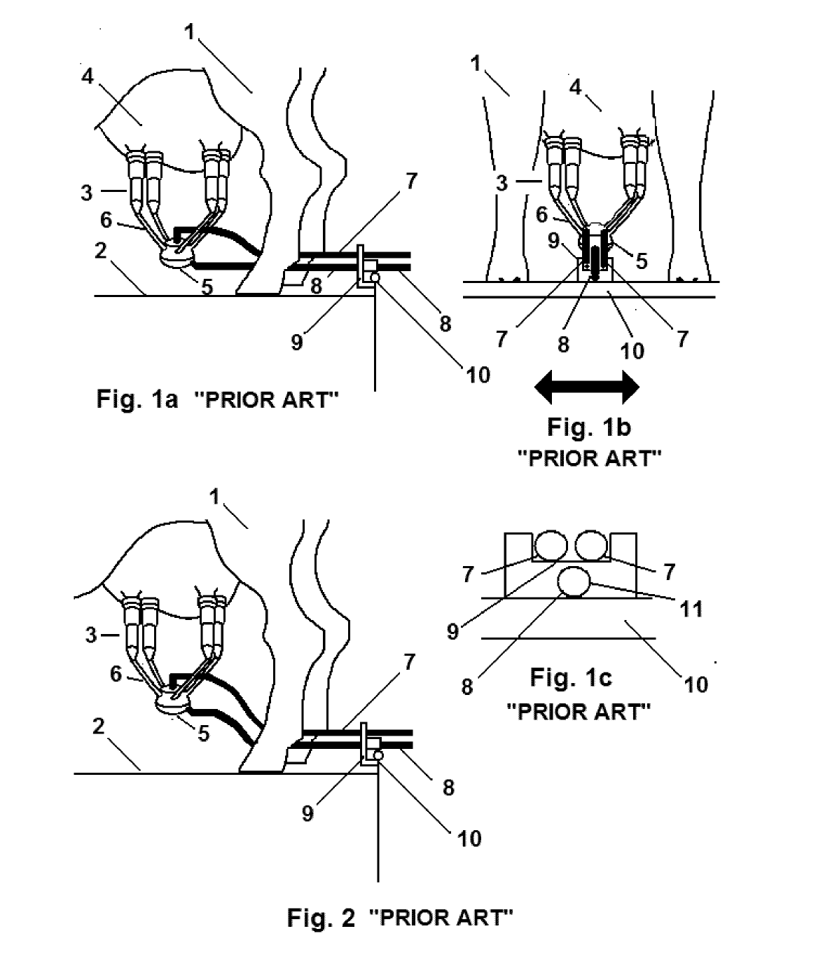

FIGS. 1a, 1b, 1c and 2 are representations of the “Prior Art” device patented to Sanford and described in the Background of the Invention section earlier in this document. The hind legs of a cow 1 are shown in FIG. 1 standing on the platform 2 of a milking stall (un-shown). Teat cups 3 are mounted upon the cow's teats (un-shown) which extend from the udder 4. A hose 6 connects each teat cup 3 to a milking machine cluster 5. The teat cups extract milk using a pair of upper hoses 7 from the centralized milk collecting system (un-shown) that supply atmospheric air and vacuum. The milk is returned to a central milk collecting system (un-shown) using a lower milk hose 8. The pair of hoses 7 are supported by a hose support surface 9. The milk hose 8 is captured in a passage 11 through hose support 9. The entire hose support assembly is supported by curb 10 and can be adjusted in a lateral direction as indicated by the arrows in FIG. 1b. There is no apparent way of achieving an up and down nor holding an in and out hose positioning adjustment.

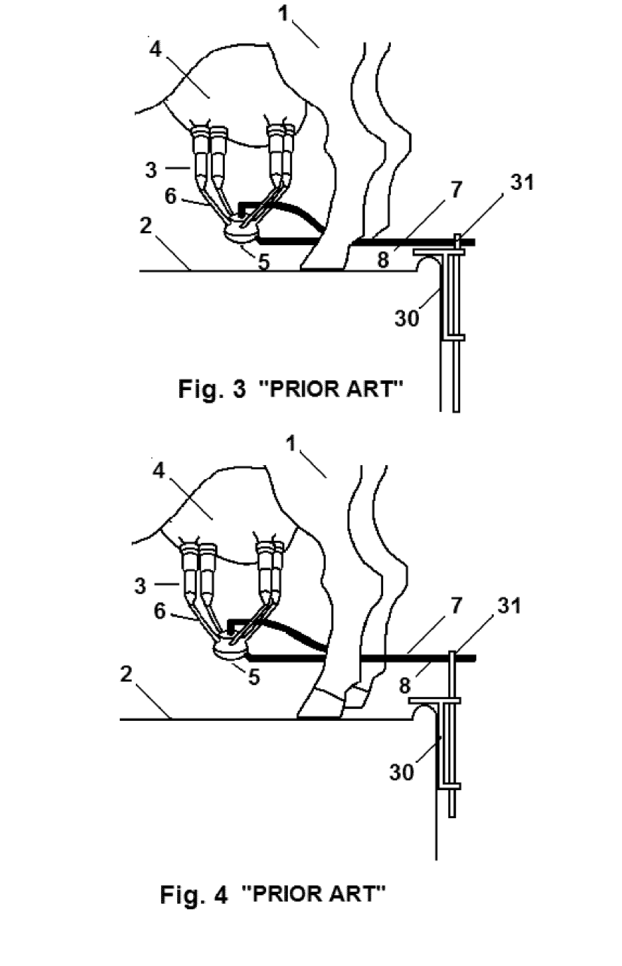

FIGS. 3 and 4 are representations of a second “Prior Art” device attributed to Maljaars. The hind legs of a cow 1 are shown standing on the platform 2 of a milking stall (un-shown). Teat cups 3 are mounted upon the cow's teats (un-shown) which extend from the udder 4. A hose 6 connects each teat cup 3 to a milking machine cluster 5. The teat cups extract milk using a pair of upper hoses 7 from the centralized milk collecting system (un-shown) that supply atmospheric air and vacuum. The milk is returned to a central milk collecting system (un-shown) using a lower milk hose 8. Both the pair of upper hoses 7 and the milk hose 8 are all supported by hose support 31. Hose support 31 is shown held by base 30 in a lower position in FIG. 3 and a higher position in FIG. 4. The support 31 slides in base 30 and is locked in place with an air actuator (un-shown). Should the device be installed in a rotary milking parlor and the hose support 31 is in the upper position when approaching an obstruction, damage to the support system will result if the locking system fails to unlock.

### DETAILED DESCRIPTION OF THE PREFERRED EMBODIMENT OF THE PRESENT INVENTION

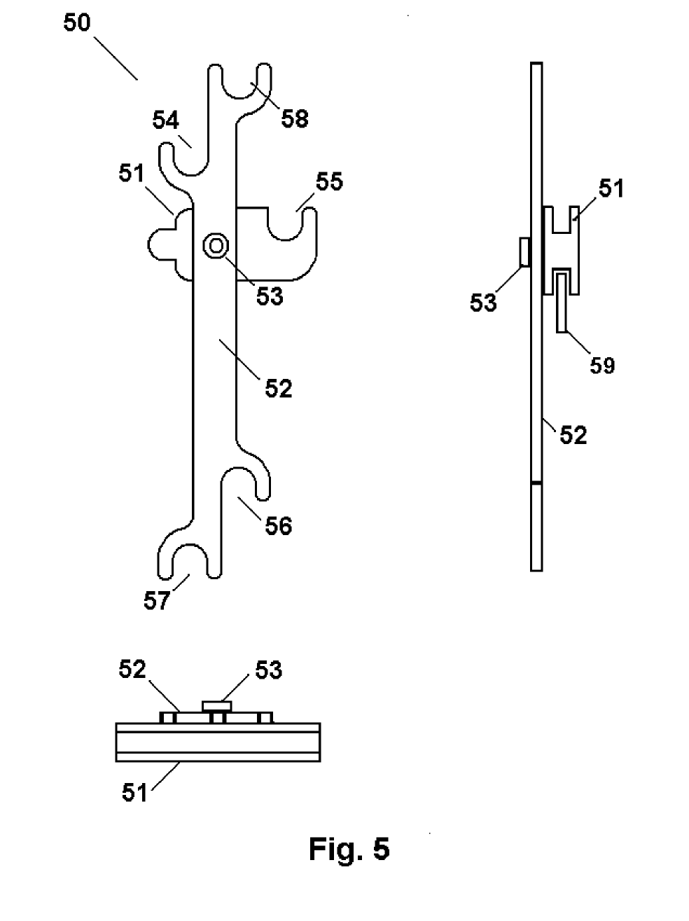

FIG. 5 shows the preferred embodiment of the present invention 50. Base 51 is supported on rail 59 which in turn is supported on the framework of the milking stall platform (un-shown). The mounting of the base 51 on the rail 59 allows for lateral adjustment of the base 51 with respect to the animal as illustrated by the arrows in FIG. 1b. The hose support tree 52 is attached to the base 51 by means of interconnection device 53 which in the preferred embodiment of the present invention is a pivot. Hose engaging member 58 is located at the top distal end of hose support tree 52 and hose engagement member 54 is located below the distal end of hose support tree 52. Should the operator (un-shown) want to raise the levels of the hoses (un-shown) the hose support tree 52 can be rotated about the interconnection device so that hose engaging member 56 and 57 are above base member 51. An additional hose support member 55 is provided to position any hose that is not placed in one of the two upper hose support members.

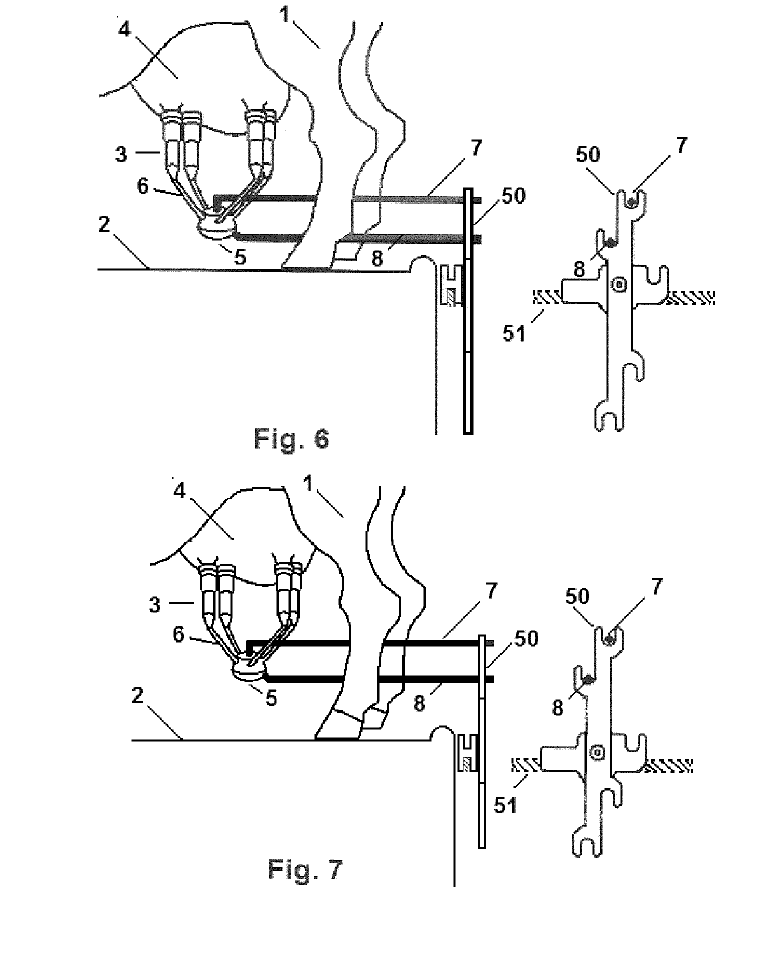

FIGS. 6 and 7 show the preferred embodiment of the present invention installed at the back of a milking stall (un-shown). FIG. 6 illustrates how the milking tree assembly is rotated to the lower hose engaging member positions for a cow 1 with teats (in the teat cups) that are close to the milking stall platform 2. FIG. 7 illustrates how the milking tree assembly is rotated to the elevated hose engaging member positions for a cow 1 with teats (in the teat cups) that are further above to the milking stall platform 2.

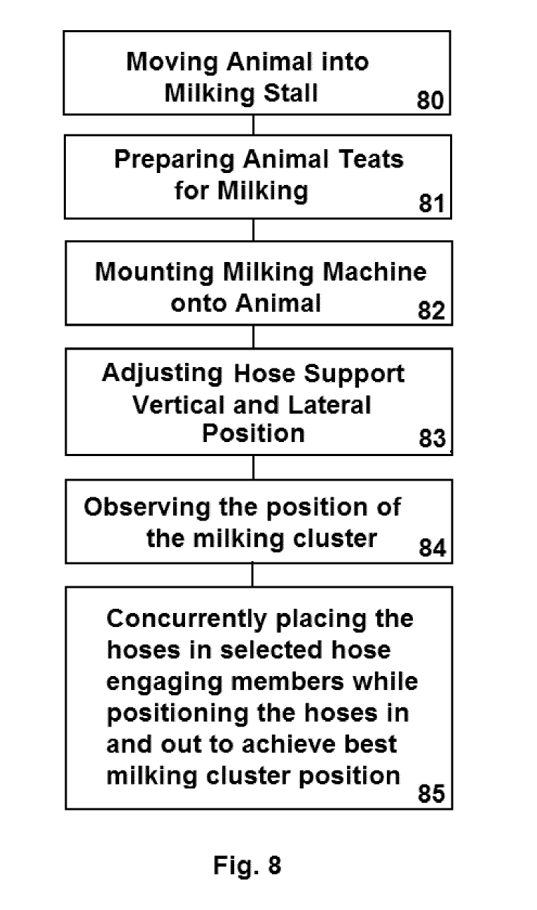

FIG. 8 illustrates the method steps for use of the preferred embodiment of the present invention. Step 80 has the operator moving the animal into the milking stall. The preferred embodiment of the present invention is made for a stall where the animal would be backed into milking position. However, it is considered to be within the spirit of the present invention to include stalls accommodating any animal position. Step 81 acknowledges the use of cleaning steps and preparations to prepare the animal for the machine interface, any of which are within the scope of the present invention. Step 82, where the milking machine is mounted onto the animal, should be carried out according to the instructions and recommendations of the milking machine manufacturer which is also considered to be within the scope of the present invention. Step 83 is done by the operator rotating the hose tree to raise the higher or lower hose engaging members to the top depending on the physical proportions of the animal. Lateral adjustment of the base on the rail is carried out concurrently to compensate for the position of the animal in the milking stall. Step 84 is merely observing what remains to be done. The last step 85 is accomplished by concurrently placing the hoses in the hose engaging members while positioning the hoses in and out to achieve the best milking cluster position.

I claim:

1. A milking machine hose support apparatus, comprising:
A base member;
A tree member extending vertically from the base member;
An interconnection device between the base member and the tree member;
One or more first hose engaging members located at distal ends of the tree member;
One or more second hose engaging members located on the tree member below the one or more first hose engaging members;
Wherein the one or more first and one or more second engaging members are located at a first elevation when the interconnection device holds the tree at a first position and the first and second engaging members are at a second elevation higher than the elevation of the first position when the interconnection device holds the tree in a second position.

2. The apparatus of claim 1, wherein:
the interconnection device is a pivot.

3. The apparatus of claim 1, wherein:
the interconnection device is a slider.

4. The apparatus of claim 1, wherein:
the interconnection device is an eccentric.

5. The apparatus of claim 1, wherein:
the tree member and base member are integral in one piece.

6. The apparatus of claim 1, wherein:
the base member is adapted for adjustment across the width of the milking stall.

7. The apparatus of claim 1, wherein:
the pivot is disposed closer to the first distal end than to the second distal end.

8. The apparatus of claim 1, wherein:
the two or more hose engaging openings are located on the tree at differing distances from the interconnecting device.

9. The apparatus of claim 1, wherein:
the hose engaging members allow the hoses to disengage freely in a vertical direction.

10. The apparatus of claim 1, wherein:
the tree member moves out of the way of an obstruction.

11. The apparatus of claim 1, wherein:
one or more of the tree member or base member are made primarily of a polymeric material.

12. The apparatus of claim 1, wherein:
at least one hose engaging member is provided on the base.

13. The apparatus of claim 1, wherein:
the base is interchangeably adapted to move on existing or added milking stall components.

14. The apparatus of claim 1, wherein:
one or more of the hose engaging members applies pressure to two surfaces of a hose to prevent relative slipping of the hose and the hose engaging member.

15. A hose support apparatus, comprising:
a base member;
a tree member extending vertically from the base member;
one or more first hose engaging members located at or near one or more distal ends of the tree member;
one or more second hose engaging members located on the tree member below the one or more first hose engaging members;
wherein the base member is adapted for lateral adjustment.

16. The apparatus of claim 15, wherein:
the hose engaging members allow the hoses to disengage freely in a vertical direction.

17. The apparatus of claim 15, wherein:
one or more of the tree member or base member are made primarily of a polymeric material.

18. The apparatus of claim 15, wherein:
at least one hose engaging member is provided on the base.

19. The apparatus of claim 15, wherein:
the tree member and base member are integral in one piece.

20. A method of use of a hose support apparatus, comprising:
Supplying a hose support tree, base and interconnecting device;
Mounting the milking machine cluster onto the animal;
Adjusting the hose rough vertical position;
Adjusting the Hose support lateral position;
Placing the hoses snugly in the hose engaging members while adjusting the in and out position of the hoses.
